(19) United States
(12) Patent Application Publication
(10) Pub. No.: US 2017/0214957 A1
(43) Pub. Date: Jul. 27, 2017

(54) METHOD AND SYSTEM FOR MANAGING APPLICATION OF SET-TOP BOX

(71) Applicant: NHN Entertainment Corporation, Seongnam-si (KR)

(72) Inventors: Kyoung Hwan Oak, Seongnam-si (KR); Hyeyoung KIM, Seongnam-si (KR)

(21) Appl. No.: 15/404,484

(22) Filed: Jan. 12, 2017

(30) Foreign Application Priority Data
Jan. 21, 2016 (KR) 10-2016-0007765

(51) Int. Cl. H04N 21/41; H04N 21/81; H04N 21/858

(52) U.S. Cl. CPC H04N 21/4104; H04N 21/8586; H04N 21/8173

(57) ABSTRACT

A method and a system for managing an application of a set-top box, method including making connection with a terminal using a local network, downloading the application from the terminal using an application store of the terminal and installing the application, receiving installation data or deletion data of the application from the terminal, and managing the application using the received installation data or the received deletion data.

### CROSS-REFERENCE TO RELATED APPLICATION

This application claims priority from and the benefit of Korean Patent Application No. 10-2016-0007765, filed on Jan. 21, 2016, which is hereby incorporated by reference for all purposes as if fully set forth herein.

### BACKGROUND

Exemplary embodiments of the inventive concept described herein relate to a method and a system for managing an application of a set-top box, and more particularly, relate to a method and a system for managing an application of a set-top box by inter-device connection through a local network communication.

In general, domestically operated application (app) stores may be classified into mobile app stores, integrated app stores (for example, K-Apps) of the mobile app stores, and smart TV app stores. Among them, mobile app stores, which distribute mobile applications, are constructed by mobile telecommunication companies to provide mobile communication services. Accordingly, a user typically accesses an app store, which is operated by a mobile telecommunication company to which the user subscribes, using a mobile terminal of the user to receive an application.

Mobile terminals manufactured by mutually different manufacturers may run the same application (without modification of the application) only if the mobile terminals are running the same operating software platform. In detail, although smart phones running an Android platform with the same version do not necessarily use the same hardware (which may vary by the manufacturer), the smart phones may run the same application regardless of the manufacturer. Nevertheless, until now, mobile telecommunication companies have mainly developed and supported mobile applications employing functions specialized for their own mobile terminals.

Accordingly, since existing set-top boxes or existing over the top (OTT) devices either have no application store or are supported by significantly fewer applications than smart phones, users may find it inconvenient to utilize the devices. In addition, since the smart phone applications may not be installed in the set-top boxes or the OTT devices, the available functions of the set-top boxes or the OTT devices are thereby limited.

The above information disclosed in this Background section is only for enhancement of understanding of the background of the inventive concept, and, therefore, it may contain information that does not form the prior art that is already known in this country to a person of ordinary skill in the art.

### SUMMARY

Exemplary embodiments of the inventive concept provide a method and a system for managing an application of a set-top box, and more particularly, provide a method and a system for managing an application of a set-top box by inter-device connection through a local network communication.

Exemplary embodiments of the inventive concept provide a method and a system for managing an application of a set-top box that is capable of performing various functions through various applications in the set-top box by installing the various applications using an app store of the terminal as the set-top box having no app store is connected with the terminal through local network communication.

According to one aspect of an exemplary embodiment, a method of managing an application of a set-top box includes making a connection with a terminal using a local network, downloading the application from the terminal using an application store of the terminal, installing the application, receiving installation data or deletion data of the application from the terminal, and managing the application using the received installation data or the received deletion data.

The making of the connection with the terminal using the local network may include providing uniform resource locator (URL) information or installation information of an embedded client application on the set-top box to the terminal for inter-device connection using the local network, and making the connection with the terminal by providing the client application based on the URL information or the installation information.

The method may include storing location determination information of the terminal when making connection with the set-top box, determining similarity between previously-stored location determination information of the terminal and current location determination information of the terminal in re-connection with the set-top box when making the re-connection with the set-top box after terminating the connection with the set-top box, and the terminal configured to search for the set-top box for inter-device connection for a period shorter than a period before the determining of the similarity when the previously-stored location determination information of the terminal is similar to the current location determination information of the terminal in the re-connection.

The making of the connection with the terminal using the local network may include making the connection with the terminal through near field communication (NFC) when close to the terminal.

The making of the connection with the terminal using the local network may include making the connection with the terminal using at least one of a bar code, a personal identification number (PIN) code, and a voice outputting device after Wi-Fi connection to provide the client application.

The making of the connection with the terminal using the local network may include reproducing a setting guide sound source or a connection sound source to enable downloading of the client application through voice search of the terminal after Bluetooth connection, and guiding reception of the client application as the setting guide sound source or the connection sound source, which is reproduced, is recognized in the voice search of the terminal.

The method may include receiving and storing at least one of a photograph, a moving picture, and a file stored in the terminal, or outputting the at least one of the photograph, the moving picture, and the file through a display device.

According to another aspect of an exemplary embodiment, a system for managing an application of a set-top box includes a local network connecting unit that makes connection with a terminal using a local network, an application storing unit that downloads the application from the terminal using an application store of the terminal and installs the application, and that receives installation data or deletion data of the application from the terminal, and an application managing unit to manage the application using the received installation data or the received deletion data.

The local network connecting unit may include an installation information providing unit that provides uniform resource locator (URL) information or installation information of a client application, which is embedded, to the terminal for inter-device connection using the local network, and a device connecting unit that makes the connection with the terminal by providing the client application to the terminal based on the uniform resource locator (URL) information or the installation information.

The terminal may include a location information storing unit that stores location determination information of the terminal when making connection with the set-top box, a location information determining unit that determines similarity between location determination information of the terminal, which is previously stored, and location determination information of the terminal in re-connection with the set-top box when making the re-connection with the set-top box after terminating the connection with the set-top box; and a device searching unit that searches for the set-top box for inter-device connection for a period shorter than a period before the determining of the similarity when the location determination information of the terminal, which is previously stored, is similar to the location determination information of the terminal in the re-connection.

The local network connecting unit may make the connection with the terminal through near field communication (NFC) when being close to the terminal.

The local network connecting unit may make the connection with the terminal using at least one of a bar code, a personal identification number (PIN) code, and a voice outputting device after Wi-Fi connection to provide the client application.

The local network connecting unit may further include a sound source providing unit that reproduces a setting guide sound source or a connection sound source to enable downloading of the client application through voice search of the terminal after Bluetooth connection, and reception of the client application may be guided as the setting guide sound source or the connection sound source, which is reproduced by the sound source providing unit, is recognized in the voice search of the terminal.

The system may further include a data managing unit that receives and stores at least one of a photograph, a moving picture, and a file, which are stored in the terminal, or that outputs the at least one of the photograph, the moving picture, and the file through a display device.

According to another aspect of an exemplary embodiment, an inter-device connection method using a local network includes providing uniform resource locator (URL) information or installation information of a client application, which is embedded in a set-top box, to a terminal for inter-device connection using the local network, and making connection between the terminal and the set-top box as the terminal receives the client application based on the uniform resource locator (URL) information or the installation information.

The inter-device connection method may further include storing location determination information of the terminal when making the connection with the set-top box, determining similarity between location determination information of the terminal, which is previously stored, and location determination information of the terminal in re-connection with the set-top box when making the re-connection with the set-top box after terminating the connection with the set-top box, and searching for the set-top box for the inter-device connection for a period shorter than a period before the determining of the similarity when the location determination information of the terminal, which is previously stored, is similar to the location determination information of the terminal in the re-connection.

### BRIEF DESCRIPTION OF THE DRAWINGS

The above and other objects and features will become apparent from the following description with reference to the following figures, wherein like reference numerals refer to like parts throughout the various figures unless otherwise specified, and wherein:

FIG. 1 is a drawing schematically illustrating a system for managing an application of a set-top box, according to an exemplary embodiment.

FIG. 2 is a drawing illustrating the configuration of a system for managing an application of a set-top box, according to an exemplary embodiment.

FIG. 3 is a block diagram to explain the configuration of a set-top box, according to an exemplary embodiment.

FIG. 4 is a block diagram to explain the configuration of a local network connecting unit of a set-top box, according to an exemplary embodiment.

FIG. 5 is a flowchart to explain a method of managing an application of a set-top box, according to an exemplary embodiment.

FIG. 6 is a flowchart illustrating an inter-device connection method using a local network, according to an exemplary embodiment.

### DETAILED DESCRIPTION OF THE ILLUSTRATED EMBODIMENTS

Exemplary embodiments will be described in detail with reference to the accompanying drawings. The inventive concept, however, may be embodied in various different forms, and should not be construed as being limited only to the illustrated embodiments. Rather, these embodiments are provided as examples so that this disclosure will be thorough and complete, and will fully convey the concept of the inventive concept to those skilled in the art. In the drawings, the shapes and sizes of elements may be exaggerated for clarity.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Exemplary embodiments of the inventive concept may provide a technology of managing an application of a set-top box by inter-device connection through local network communication. According to exemplary embodiments of the inventive concept, various functions may be performed through various applications in the set-top box by installing the various applications using an application (app) store of the terminal as the set-top box having no app store is connected with the terminal through local network communication.

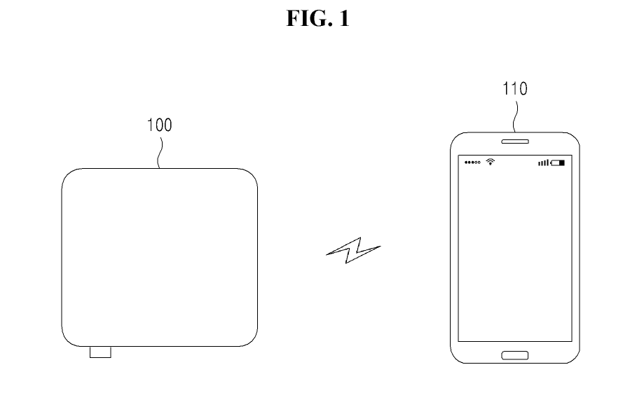

FIG. 1 is a drawing schematically illustrating a system for managing an application of a set-top box according to an exemplary embodiment.

Referring to FIG. 1, the system for managing the application of the set-top box may include a set-top box 100 and a terminal 110 connected with the set-top box 100.

The set-top box 100 may be connected with an external display device to appropriately convert a signal input from the outside and to display a converted signal on the external display device. In this case, the set-top box 100 may include an electric/electronic appliance having no application (app) store or supporting applications fewer than those supported by an app store of the terminal.

For example, the set-top box 100 may be one of various electric/electronic appliances such as an over the top (OTT) device, digital satellite broadcast receiving equipment, a router, a home appliance, a cloud-based thin client device (cloud-based box), and a connected home appliance. The cloud-based box or the connected home appliance may include the set-top box or the OTT device. Hereinafter, a device, such as the cloud-based box, the connected home appliance, or the OTT device, is collectively referred to as “set-top box”.

The terminal 110 may receive a signal from the set-top box 100 and may provide an application, which is requested, to the set-top box 100 using the app store installed on the terminal 110. In addition, the terminal 110 may share data, such as a photograph, a video, or a file, with the set-top box 100.

The terminal 110, which serves as an electronic device, may be a stationary terminal or a mobile terminal realized by a computer device. For example, the terminal 110 may be, but is not limited to, a smart phone, a cellular phone, a navigation device, a notebook computer, a tablet device, a digital broadcast terminal, a personal digital assistant (PDA), a portable multimedia player (PMP), and an e-book reader.

The terminal 110 may make communication with the set-top box, another terminal, and/or a server via a network through a wireless communication scheme or a wired communication scheme, and may install an application thereon using a file provided by the server.

The server may be realized by a computer device or a plurality of computer devices that are in communication with the terminal 110 via a network to provide instructions, codes, files, content, services, and the like.

For example, the server may provide an installation file of an application for the terminal 110 accessing the server via the network. In this case, the terminal 110 may install the application thereon using the installation file provided by the server. In addition, the terminal 110 may access the server under the control of an operating system (OS) and at least one program (for example, a browser or an installed application), which are included on the terminal 110, to receive services or content provided by the server. For example, when the terminal 110 transmits a service request message to the server via the network under the control of the application, the server may transmit codes corresponding to the service request message to the terminal 110, and the terminal 110 may form and display a screen image based on the codes under the control of the application, thereby providing content for a user. In this case, the terminal 110 may receive various applications from the server using the app store (or market) installed thereon.

In addition, a device or a communication system may be used to connect the set-top box 100 and the terminal 110 with each other wirelessly or by wires.

For example, the set-top box 100 and the terminal 110 may be formed therein with respective USB ports and connected in a wired manner with each other through a USB cable. When the set-top box 100 and the terminal 110 are connected with each other via the USB cable, a necessary service may be provided through a simple configuration and a simple scheme based on a communication protocol to support an integrated data field that a terminal and a device are connected with each other.

For example, when the set-top box 100 and the terminal 110 are USB-connected with each other based on an Android Debug Bridge (ADB), a Media Transfer Protocol (MTP), or a Picture Transfer Protocol (PTP), a desired application may be download from the app store of the terminal 110 and installed on the set-top box 100.

The ADB, which is a communication protocol to transmit an instruction to an Android terminal and to receive an instruction result from the Android terminal, may refer to a program to issue an instruction to an Android operating system device.

The MTP and the PTP are connection schemes that help file transfer by connecting the terminal with a device such as a computer.

According to another example, the set-top box 100 and the terminal 110 may include respective wireless communication modules to be connected with each other through wireless communication.

As described above, various communication schemes may be employed. A wireless communication scheme may include not only a communication scheme to utilize a telecommunication network (for example, a mobile communication network, wired Internet, wireless Internet, and a broadcast network), but also a short-range radio communication scheme between devices. For example, the network may include at least any one among a personal area network (PAN), a local area network (LAN), a campus area network (CAN), a metropolitan area network (MAN), a wide area network (WAN), and a broadband network (BBN). In addition, the network may include at least any one among network topologies including a bus network, a star network, a ring network, a mesh network, a star bus network, and a tree or hierarchical network, but the inventive concept is not limited thereto.

In particular, the set-top box 100 and the terminal 110 may be connected with each other using a local network (e.g., Wi-Fi Direct, NFC, Bluetooth, or the like).

In this case, the local network is a local information communication network in which devices are connected with each other within a shorter distance. The local network may include a network constructed at home or at office, similar to a local area network (LAN). Nodes of the local network may be linked with each other in a dedicated line or may be wirelessly connected with each other using an access point (AP) or a wireless LAN card.

Therefore, the set-top box 100 and the terminal 110 may interwork with each other. In this case, the interworking between the set-top box 100 and the terminal 110 may refer to that the set-top box 100 downloads an application from the terminal 110 using the app store installed in the terminal 110 and installs the application therein, and the terminal 110 shares a photograph, a moving picture, or a file, which is stored therein, with the set-top box 100 in communication between the se-top box 100 and the terminal 110.

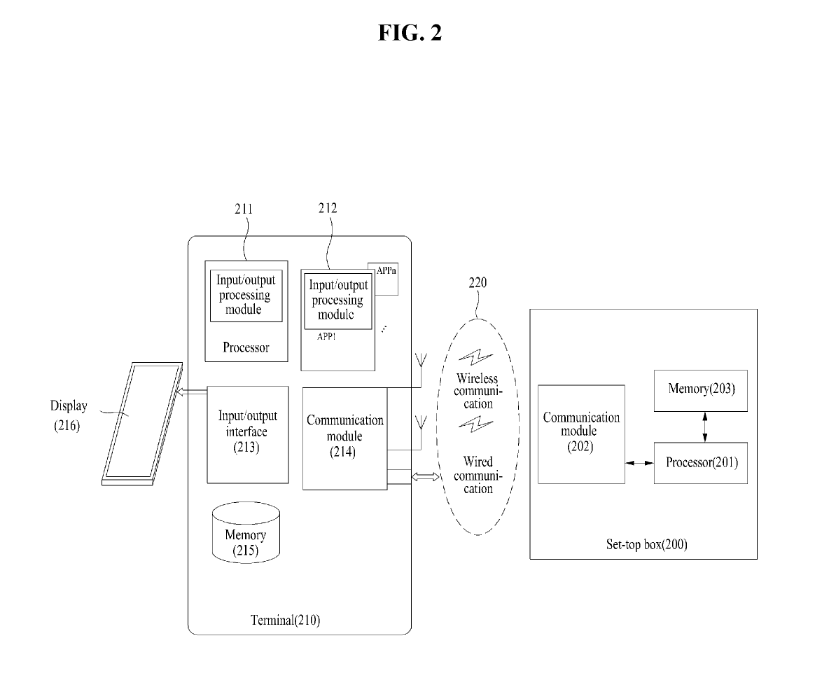

FIG. 2 is a drawing illustrating the configuration of a system for managing an application of a set-top box according to an exemplary embodiment.

Referring to FIG. 2, the system for managing the application of the set-top box may include a set-top box 200 and a terminal 210 generally as described above with respect to set-top box 100 and a terminal 110.

In this case, the set-top box 200 may be a device, such as a cloud-based box, a connected home appliance, or an OTT device, to download an application using an app store of the terminal 210 and to install the application therein. In addition, the terminal 210 may be a device, such as a cellular phone, a smart phone, or a tablet personal computer (PC), to receive a signal from the set-top box 200 and to provide an application, which is requested by the set-top box 200, for the set-top box 210 using the app store installed on the terminal 200.

As described above, the set-top box 200 may be paired with the terminal 210 to download an application using the app store installed in the terminal 210 and to install the application therein, thereby providing various functions based on the application. Such functions will be described below in more detail.

In this case, at least one set-top box 200 may be provided, and at least one terminal 210 may be provided. For example, a plurality of set-top boxes 200 may be paired with one terminal 210. According to another example, a plurality of set-top boxes 200 may be paired with a plurality of terminals 210.

Hereinafter, the internal configurations of a set-top box 200 and a terminal 210 serving as examples of one set-top box and one terminal will be described with reference to FIG. 2.

For example, the terminal 210 may include a processor 211, an input/output interface 213, a communication module 214, a memory 215, and a display 216. The terminal 210 may include at least one of applications running on the processor 211 and the terminal 210. At least one of the processor 211 and/or the applications may include an input/output processing module.

The terminal 210 and the set-top box 200 may include memories 203 and 215, processors 201 and 211, communication modules 202 and 214, and an input/output interface 213.

The memories 203 and 215 may include a random access memory (RAM), a read only memory (ROM), and a permanent mass storage such as a disk drive, which are computer-readable recording media. In addition, the memories 203 and 215 may store an operating system and at least one program code (for example, codes for a browser or the above-described application installed or run in the terminal 210). The software elements may be loaded from computer-readable recording media provided separately from the memories 203 and 215 using a drive mechanism. Such computer-readable recording media may include a floppy drive, a disk, a tape, a DVD/CD-ROM drive, or a memory card. According to another exemplary embodiment, the software elements may be loaded into the memories 203 and 215 through the communication modules 202 and 214 instead of the computer readable recording media. For example, at least one program may be loaded into the memories 203 and 215 based on programs (for example, the above-described application) installed through files provided by developers or file distribution systems (for example, the above-described server), which distributes installation files for applications, via the network.

The processors 201 and 211 may be configured to process instructions of a computer program by performing basic arithmetic, logic, and I/O operations. The instructions may be provided for the processors 201 and 211 through the memories 203 and 215 or the communication modules 202 and 214. For example, the processors 201 and 211 may be configured to execute the received instructions based on program codes stored in recording devices such as the memories 203 and 215.

The communication modules 202 and 214 may provide functions of allowing the terminal 210 and the set top box 200 to make communication with each other or to make communication with another terminal or another set-top box via a network 220. For example, a request created by the processor 211 of the terminal 210 based on the program code stored in a recording device, such as the memory 215, may be transmitted to the set top box 200 via the network 220 under the control of the communication module 214. In addition, a control signal, an instruction, content, or a file, which is provided under the control of the processor 201 of the set-top box 200, may be received in the terminal 210 through the communication module 214 of the terminal 210 after passing through a communication module 202 and the network 220. For example, the control signal or the instruction of the set-top box 200 received through the communication module 214 may be transmitted to the processor 211 or the memory 215, and the content or the file may be stored in a storage medium which may be further included in the terminal 210.

The input/output interface 213 may be a unit to interface with an input/output device. For example, the input device may include a device such as a keyboard or a mouse, and the output device may include a device such as a display to display a communication session of an application. According to another example, the input/output interface 213 may be a unit to interface with a device, such as a touch screen, having an integrated input/output function. In more detail, the processor 211 of the terminal 210 may display a service screen image or content, which is formed based on data provided by the set-top box 200 or another terminal, on the display 216 through the input/output interface 213 when processing an instruction of a computer program loaded into the memory 215.

According to other exemplary embodiments, the terminal 210 and the set-top box 200 may include more elements than those of FIG. 2. However, all elements according to the related art need not be clearly illustrated. For example, the terminal 210 may be realized to include at least part of the input/output devices or may further include other elements such as a transceiver, a global positioning system (GPS) module, a camera, various sensors, and a database.

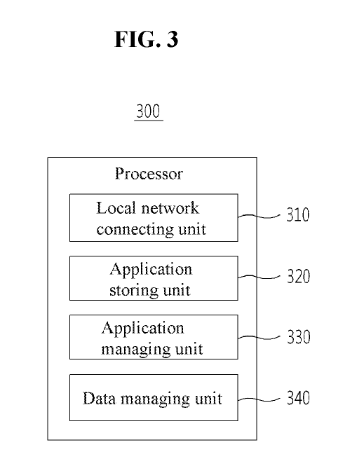

FIG. 3 is a block diagram to explain the configuration of a set-top box according to an exemplary embodiment.

Referring to FIG. 3, a system 300 for managing an application of a set-top box may include a local network connecting unit 310, an application storing unit 320, and an application managing unit 330. According to an exemplary embodiment, the system for managing the application of the set-top box may further include a data managing unit 340.

The local network connecting unit 310 may be connected with the terminal using a local network. In this case, the first physical layer link may be performed through an existing technology.

In this case, the local network is a communication network, in which devices are connected with each other within a shorter distance, and may include, but is not limited to, Wi-Fi Direct, near field communication (NFC), or Bluetooth. The local network may include a network constructed at home or at office, similar to a LAN. Nodes of the local network may be linked with each other in a dedicated line or may be wirelessly connected with each other using an access point (AP) or a wireless LAN card.

The local network connecting unit 310 may provide uniform resource locator (URL) information or download information of a client application, which is embedded in the set-top box, to the terminal when making connection with the terminal using the local network. Accordingly, the client application may be downloaded to the terminal and installed in the terminal. In this case, the client application allows the terminal and the set-top box to share installation files of various applications using the local network as the terminal and the set-top box are connected with each other. The client application may be previously installed in the set-top box. In addition, as the client application is installed in both of the set-top box and the terminal, the set-top box and the terminal may share a data file such as a photograph, a moving picture, or a file.

According to one example, when the device is connected with the terminal in a near field communication (NFC) enable state, the terminal may download the client application thereto using the local network.

According to another example, after making connection with the terminal through Wi-Fi direct, the local network connecting unit 310 provides at least one among a uniform resource locator (URL), an image (of a bar code, or a personal identification number (PIN) code), and a voice outputting device to the terminal. Accordingly, the terminal may download the client application thereto using the local network.

According to another example, after making connection with the terminal through Bluetooth, the local network connecting unit 310 may reproduce a setting guide sound source or a connection sound source to guide the downloading of the client application using a voice search function of the terminal.

When making connection with the terminal using the local network, the local network connecting unit 310 may store present location determination information of the terminal in order to facilitate the next connection with the terminal.

According to one example, when the local network connecting unit 310 makes re-connection using information, such as a Wi-Fi Media Access Control (Wi-Fi MAC) address or SSid, for the location determination, and when the same information is present, the local network connecting unit 310 may determine a present location as being a location to be connected.

According to another example, when the local network connecting unit 310 makes re-connection using information of a global positioning system (GPS) for the location determination, and when the local connecting unit 310 is located around a registration location, the local network connecting unit 310 may search for a device to be connected by making an inter-device connection period shorter.

According to another example, the local network connecting unit 310 may acquire image data from an image recognizing or taking device, such as a camera, of the terminal for the location determination, thereby collecting and identifying the image data for a predetermined period in an inter-device connection state. For example, when the local network connecting unit 310 is located around the registered location based on the information of the GPS, inter-device connection is made by making the inter-device connection period shorter. Then, image data may be collected by the camera to verify similarity between the image data and previously-stored image data, thereby determining the location of the terminal.

Accordingly, the local network connecting unit 310 may search for a peer device for inter-device connection for a period shorter than a previous period when the local network connecting unit 310 makes re-connection with the terminal after terminating the established connection with the terminal and when a present location is determined as being similar to an initial connection location based on previously-stored location determination information.

The application storing unit 320 may download an application from the terminal using the app store of the terminal and may install the application, after connection with the terminal. In this case, the app store (or market) installed in the terminal may be a Google P1ay™ store if an Android operating system (OS) is installed in the terminal, and may be the Apple® App Store if an Apple OS is installed in the terminal.

The application storing unit 320 may receive installation data or deletion data of the application, which is used to manage the application, from the terminal.

As the application storing unit 320 downloads a required application thereto from the app store of the terminal and installs the application therein, a device having no app store may use various functions based on the application. In this case, the application storing unit 320 may install and use most applications of the app store. For example, the application storing unit 320 may install applications, such as Bugs™, Tomiko™, or Toast Cam™ from NHN Entertainment Corporation, therein through the terminal and use the applications. These application are disclosed only for illustrative purpose, but the inventive concept is not limited thereto.

The application managing unit 330 may manage the installed application even in the set-top box by installing or deleting the application using the installation data or deletion data received from the terminal.

According to an exemplary embodiment, the system for managing the application of the set-top box may further include a data managing unit 340.

The data managing unit 340 may receive and store at least one of a photograph, a moving picture, and a file stored in the terminal, or may display the at least one of the photograph, the moving picture, and the file through a display device.

The data managing unit 340 may be run in a server-client structure over the local network. For example, the data managing unit 340 in the set-top box may request the terminal to transmit data, such as a photograph, a moving picture, or a file, and the terminal may transmit the requested data to the data managing unit 340 in response to the request. In other words, the data managing unit 340 may request necessary data, such as the photography, the moving picture, or the file, from the terminal, may receive the necessary data from the terminal, and may store or display the received photograph, moving picture, or file.

The data managing unit 340 may copy or move a data file of the terminal.

In addition, the data managing unit 340 may perform an automatic backup function in an inter-device communication enable state using a local network.

As described above, when the set-top box is connected with the terminal through local network communication, the set-top box may receive, store, and display a data file, such as a photograph, a moving picture, or a file, of the terminal. In addition, the set-top box may transmit a data file thereof to the terminal and may store and display the data file through the terminal.

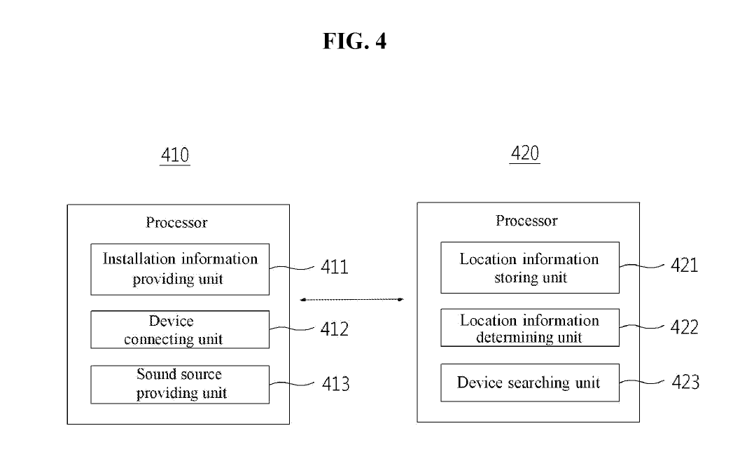

FIG. 4 is a block diagram to explain the configuration of a local network connecting unit of a set-top box according to an exemplary embodiment.

Referring to FIG. 4, in a system for managing an application of a set-top box, a local network connecting unit 410 of the set-top box may include an installation information providing unit 411 and a device connecting unit 412. In addition, according to an exemplary embodiment, the local network connecting unit 410 in the system for managing the application of the set-top box may further include a sound source providing unit 413. In addition, according to an exemplary embodiment, the local network connecting unit 410 in the system for managing the application of the set-top box may further include a location information storing unit, a location information determining unit, and a device searching unit.

The installation information providing unit 411 provides URL information or installation information of a client application to the terminal. In more detail, the installation information providing unit 411 may provide the URL information or the installation information of the client application, which is embedded therein, for inter-device connection using a local network.

According to one example, the installation information providing unit 411 of the local network connecting unit 410 may be connected with the terminal through NFC communication when being close to a predetermined distance from the terminal.

According to another example, the installation information providing unit 411 of the local network connecting unit 410 may be connected with the terminal using at least one of a bar code, a PIN code, and a voice outputting device after Wi-Fi connection with the terminal to provide the client application.

In addition, according to an exemplary embodiment, the local network connecting unit 410 in the system for managing the application of the set-top box may further include the sound source providing unit 413.

The sound source providing unit 413 may reproduce a setting guide sound source or a connection sound source to enable the downloading of the client application through a voice search function of the terminal after forming a Bluetooth connection with the terminal. Accordingly, the installation information providing unit 411 of the local network connecting unit 410 may guide the reception of the client application in the terminal as the setting guide sound source or the connection sound source, which is reproduced in the sound source providing unit 413, is recognized in the voice search of the terminal.

Accordingly, the device connecting unit 412 may provide the client application based on the URL information or installation information to make connection with the terminal.

In this case, when making a connection with the set-top box using the local network, the terminal 420 may store the present location determination information in order to facilitate the next connection with the set-top box. The terminal 420 may include a location information storing unit 421, a location information determining unit 422, and a device searching unit 423 to facilitate the next connection by storing the present location determination information.

The location information 421 storing unit may store location determination information of the terminal when making a connection with the set-top box.

The location information 422 determining unit may determine similarity between previously-stored location determination information of the terminal and current location determination information of the terminal in re-connection when making the re-connection with the set-top box after terminating the connection with the set-top box.

The device searching unit 423 may search for the set-top box serving as a device for the inter-device connection for a period shorter than a period before the determination of the similarity when the previously-stored location determination information of the terminal is similar to the current location determination information of the terminal in the re-connection.

When making a connection with the terminal using the local network, the set-top box may store present location determination information in order to facilitate the next connection with the terminal. The set-top box may include a location information storing unit, a location information determining unit, and a device searching unit to facilitate the next connection with the terminal by storing the present location determination information of the terminal.

The location information storing unit may store the location determination information of the terminal when making a connection with the terminal.

The location information determining unit may determine similarity between previously-stored location determination information of the terminal and current location determination information of the terminal in re-connection, when making the re-connection with the terminal after terminating the connection with the terminal.

The device searching unit may search for the terminal for the inter-device connection for a period shorter than a period before the determination of the similarity when the previously-stored location determination information of the terminal is similar to the current location determination information of the terminal in the re-connection with the terminal.

For example, when a user carrying with the terminal returns to home equipped with a set-top box, the terminal and the set-top box may be connected with each other using the local network constructed at the home of the user.

In detail, the terminal may determine the similarity between the previously-stored location determination information of the terminal and the current location determination information of the terminal in re-connection when making re-connection with the set-top box. In addition, the device searching unit of the terminal searches for the set-top box serving as a device for the inter-device connection for a period shorter than a period before the determination of the similarity when the previously-stored location determination information of the terminal is similar to the current location determination information of the terminal in the re-connection with the set-top box. Accordingly, the terminal may be rapidly connected with the set-top box.

Thereafter, the terminal may transmit a data file, such as a photograph, a moving picture, or a file, to the set-top box to display the data file through a display device (TV) connected with the set-top box. In this case, the set-top box may be connected with or equipped with the display device.

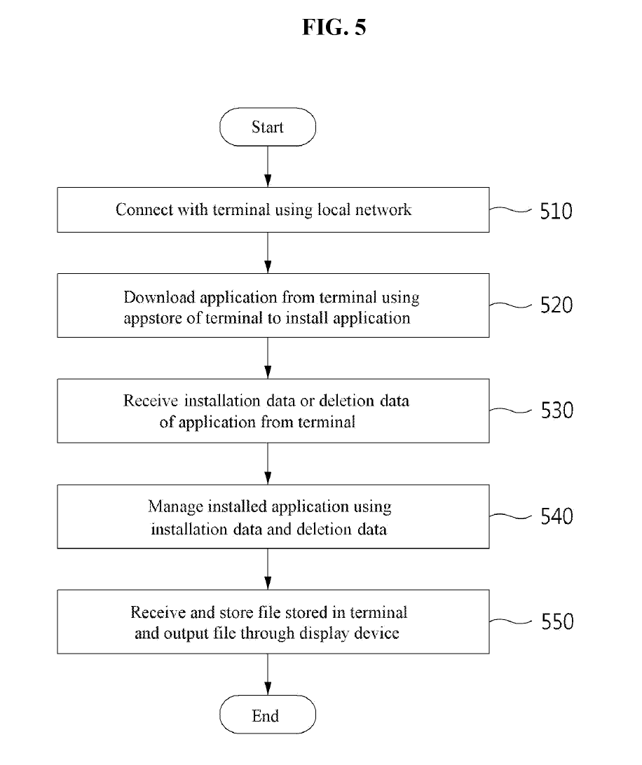

FIG. 5 is a flowchart to explain a method of managing an application of a set-top box according to an exemplary embodiment.

Referring to FIG. 5, a method of managing an application of a set-top box includes making a connection with a terminal using a local network (step 510), downloading the application from the terminal using an app store of the terminal to install the application (step 520), receiving installation data or deletion data of the application from the terminal (step 530), and managing the installed application using the received installation data or the received deletion data (step 540).

In more detail, the making of the connection with the terminal using the local network (step 510) includes providing URL information or installation information of the client application, which is embedded in the set-top box, to the terminal using the local network for inter-device connection (step 511), and making the connection with the terminal based on the URL information or the installation information (step 512).

In addition, the method may further include receiving and storing at least one of a photograph, a moving picture, and a file stored in the terminal, or outputting the at least one of the photograph, the moving picture, and the file through a display device (step 550).

According to an exemplary embodiment, a set-top box having no app store may be connected with a terminal via local network communication to install various applications using the app store of the terminal. Accordingly, the set-top box may not only perform various functions through the applications, but also manage, for example, install and delete the application.

Hereinafter, the method of managing the application of the set-top box according to an exemplary embodiment will be described in more detail by using the system for managing the application of the set-top box according to an exemplary embodiment described with reference to FIGS. 3 and 4. As described with reference to FIG. 3, according to an exemplary embodiment, the system for managing the application of the set-top box may include the local network connecting unit 310, the application storing unit 320, and the application managing unit 330. According to an exemplary embodiment, the system for managing the application of the set-top box may further include the data managing unit 340. As described with reference to FIG. 4, according to an exemplary embodiment, the local network connecting unit 410 in the system for managing the application of the set-top box may include the installation information providing unit 411 and the device connecting unit 412. In addition, according to an exemplary embodiment, the local network connecting unit 410 in the system for managing the application of the set-top box may further include the sound source providing unit 413.

In step 510, the local network connecting unit may be connected with the terminal using the local network.

To make connection with the terminal using the local network, in step 511, the installation information providing unit of the local network connecting unit may use the local network to provide the URL information or the installation information of the embedded client application to the terminal for inter-device connection.

In step 512, the device connecting unit of the local network connecting unit may be connected with the terminal based on the URL information or the installation information.

For example, to make connection with the terminal using the local network, the local network connecting unit may be connected with the terminal through NFC communication when being close to a predetermined distance from the terminal.

According to another example, the local network connecting unit may be connected with the terminal using at least one of the bar code, the PIN code, and the voice outputting device after Wi-Fi connection, to provide the client application.

According to another example, the local network connecting unit may reproduce the setting guide sound source or the connection sound source to enable the downloading of the client application through the voice search of the terminal after Bluetooth connection with the terminal. In addition, the local network connecting unit may guide the reception of the client application in the terminal as the setting guide sound source or the connection sound source, which is reproduced, is recognized in the voice search of the terminal.

Location determination information of the terminal may be stored in connection with the terminal to make connection with the terminal using the local network. Thereafter, the location information determining unit may determine similarity between the location determination information of the terminal, which is previously stored, and location determination information of the terminal in re-connection with the set-top box when making the re-connection with the set-top box after terminating the connection with the set-top box. In addition, a peer device may be searched for the inter-device connection for a period shorter than a period before the similarity determination when the location determination information of the terminal, which is previously stored, is similar to the location determination information of the terminal in the re-connection with the set-top box.

In step 520, the application storing unit may download an application from the terminal using an app store of the terminal and may install the application. The application storing unit may download various applications using the app store installed in the terminal using the local network in the state that the set-top box is paired with the terminal by the local network connecting unit. In this case, the app store installed in the terminal may be the Google Play store if an Android OS is installed in the terminal, and may be the Apple App Store if an Apple OS is installed in the terminal.

In step 530, the application storing unit may receive installation data or deletion data of the application from the terminal. In more detail, after selecting an application to be installed or deleted using the app store installed in the terminal, the application storing unit may receive data related to the installation or the deletion of the application in the set-top box.

In step 540, the application managing unit may mange the application using the received installation data or the received deletion data.

In addition, according to an exemplary embodiment, the method of managing the application of the set-top box may be performed by receiving data stored in the terminal.

In step 550, the data managing unit may receive and store at least one of a photograph, a moving picture, and a file stored in the terminal, or may display the at least one of the photograph, the moving picture, and the file through a display device.

In this case, the data managing unit may be run in the structure of a server (for example, terminal) and a client (for example, set-top box) in a local network. In addition, the data managing unit may copy a data file, such as a photograph, a moving picture, or a file, of the terminal and may move the copied data file to the set-top box.

Further, the data managing unit may be set to be automatically backed up in the state of enabling inter-device communication with the terminal using the local network.

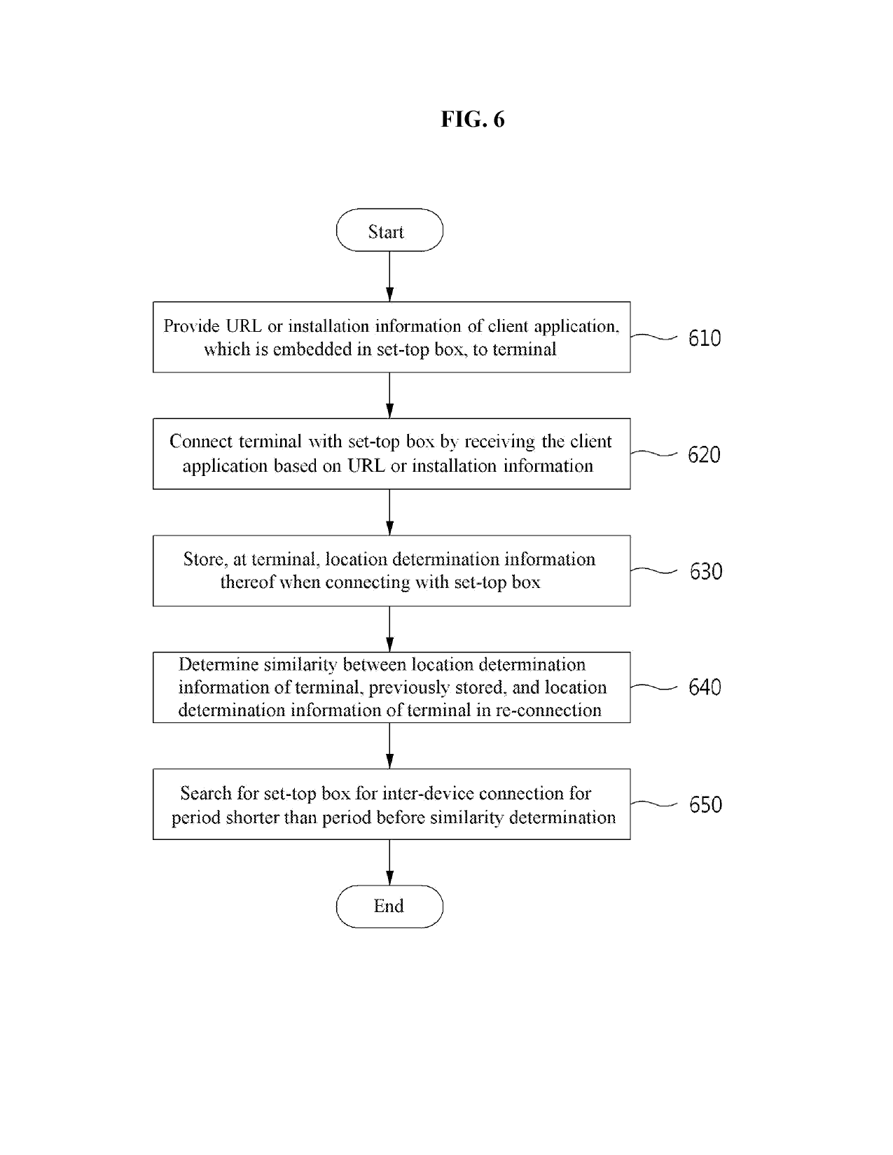

FIG. 6 is a flowchart illustrating an inter-device connection method using a local network, according to an exemplary embodiment.

Referring to FIG. 6, since the method of connecting the terminal with the set-top box has been described in detail with reference to FIGS. 3 to 5, the details of same parts will be omitted from the following description of the inter-device connection method using the local network according to an exemplary embodiment.

In step 610, the set-top box may provide URL information or installation information of a client application, which is embedded therein, to a terminal for inter-device connection using the local network.

In step 620, the terminal may make connection with the set-top box by receiving the client application based on the URL information or the installation information.

In step 630, the terminal may store location determination information thereof when making connection with the set-top box.

In step 640, the terminal may determine similarity between the location determination information of the terminal, which is previously stored, and location determination information of the terminal in re-connection when making the re-connection with the set-top box after terminating the connection with the set-top box.

In step 650, the terminal may search for the set-top box for the inter-device connection for a period shorter than a period before the similarity determination when the location determination information of the terminal in the re-connection with the set-top box is similar to the location determination information of the terminal which is previously stored.

Accordingly, the terminal and the set-top box may be connected with each other using the local network.

As described above, according to an exemplary embodiment, the set-top box having no app store is connected with the terminal through local network communication to install various applications using the app store of the terminal. Accordingly, the set-top box may not only perform various functions using the applications installed through the terminal, but also manage, for example, install and delete, the application.

In addition, as the set-top box is connected with the terminal through local network communication, the set-top box may receive, store, and display a data file, such as a photograph, a moving picture, or a file, of the terminal. In addition, the set-top box may transmit a data file thereof to the terminal and may store and display the data file through the terminal.

The foregoing devices may be realized by hardware elements, software elements and/or combinations thereof. For example, the devices and elements illustrated in the exemplary embodiments of the inventive concept may be implemented in one or more general-use computers or special-purpose computers, such as a processor, a controller, an arithmetic logic unit (ALU), a digital signal processor, a microcomputer, a field programmable array (FPA), a programmable logic unit (PLU), a microprocessor or any device which may execute instructions and respond. A processing unit may implement an operating system (OS) or one or software applications running on the OS. Further, the processing unit may access, store, manipulate, process and generate data in response to execution of software. It will be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Alternatively, the processing unit may have a different processing configuration, such as a parallel processor.

Software may include computer programs, codes, instructions or one or more combinations thereof and configure a processing unit to operate in a desired manner or independently or collectively control the processing unit. Software and/or data may be permanently or temporarily embodied in any type of machine, elements, physical equipment, virtual equipment, computer storage media or units or transmitted signal waves so as to be interpreted by the processing unit or to provide instructions or data to the processing unit. Software may be distributed throughout computer systems connected via networks and be stored or executed in a distribution manner. Software and data may be recorded in one or more computer-readable storage media.

The methods according to the above-described exemplary embodiments of the inventive concept may be recorded in computer-readable media including program instructions to implement various operations embodied by a computer. The media may also include, alone or in combination with the program instructions, data files, data structures, and the like. The program instructions recorded in the media may be designed and configured specially for the exemplary embodiments of the inventive concept or be known and available to those skilled in computer software. Computer-readable media include magnetic media such as hard disks, floppy disks, and magnetic tape; optical media such as CD ROM disks and DVDs; magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and files containing higher level code that may be executed by the computer using an interpreter. The described hardware devices may be configured to act as one or more software modules to perform the operations of the above-described exemplary embodiments of the inventive concept, or vice versa.

As descried above, according to an exemplary embodiment, in the method and the system for managing the application of the set-top box, the set-top box having no app store is connected with the terminal through local network communication to install various applications using the app store of the terminal. Accordingly, the set-top box may not only perform various functions using the applications installed, but also manage, for example, install and delete, the application.

While exemplary embodiments have been shown and described with reference to the accompanying drawings, it will be apparent to those skilled in the art that various modifications and variations can be made from the foregoing descriptions. For example, adequate effects may be achieved even if the foregoing processes and methods are carried out in different order than described above, and/or the aforementioned elements, such as systems, structures, devices, or circuits, are combined or coupled in different forms and modes than as described above or be substituted or switched with other elements or equivalents.

Accordingly, the inventive concept is not limited to such embodiments, but rather to the broader scope of the presented claims and various obvious modifications and equivalent arrangements.

What is claimed is:

1. A method of managing an application of a set-top box, the method comprising:
making a connection with a terminal using a local network;
downloading the application from the terminal using an application store of the terminal and installing the application;
receiving installation data or deletion data of the application from the terminal; and
managing the application using the received installation data or the received deletion data.

2. The method of claim 1, wherein the making of the connection with the terminal using the local network comprises:
providing uniform resource locator (URL) information or installation information of an embedded client application to the terminal for inter-device connection using the local network; and
making the connection with the terminal by providing the client application based on the URL information or the installation information.

3. The method of claim 1, further comprising:
storing, by the terminal, location determination information of the terminal when making connection with the set-top box;
determining, by the terminal, similarity between previously-stored location determination information of the terminal and current location determination information of the terminal in re-connection with the set-top box when making the re-connection with the set-top box after terminating the connection with the set-top box; and
searching for, by the terminal, the set-top box for inter-device connection for a period shorter than a period before the determining of the similarity when the previously-stored location determination information of the terminal is similar to the current location determination information of the terminal in the re-connection.

4. The method of claim 1, wherein the making of the connection with the terminal using the local network comprises making the connection with the terminal through near field communication (NFC) when the set-top box is within NFC range of the terminal.

5. The method of claim 2, wherein the making of the connection with the terminal using the local network comprises making the connection with the terminal using at least one of a bar code, a personal identification number (PIN) code, and a voice outputting device after Wi-Fi connection to provide the client application.

6. The method of claim 2, wherein the making of the connection with the terminal using the local network comprises:
reproducing a setting guide sound source or a connection sound source to enable downloading of the client application through voice search of the terminal after Bluetooth connection; and
guiding reception of the client application as the setting guide sound source or the connection sound source, which is reproduced, is recognized in the voice search of the terminal.

7. The method of claim 1, further comprising:
receiving and storing at least one of a photograph, a moving picture, and a file stored in the terminal, or outputting the at least one of the photograph, the moving picture, and the file through a display device.

8. A system for managing an application of a set-top box, the system comprising:
a local network connecting unit configured to make connection with a terminal using a local network;
an application storing unit configured to download the application from the terminal using an application store of the terminal and to install the application, and configured to receive installation data or deletion data of the application from the terminal; and
an application managing unit to manage the application using the received installation data or the received deletion data.

9. The system of claim 8, wherein the local network connecting unit comprises:
an installation information providing unit configured to provide uniform resource locator (URL) information or installation information of an embedded client application to the terminal for inter-device connection using the local network; and
a device connecting unit configured to make the connection with the terminal by providing the client application to the terminal based on the uniform resource locator (URL) information or the installation information.

10. The system of claim 8, wherein the terminal comprises:
a location information storing unit configured to store location determination information of the terminal when making connection with the set-top box;
a location information determining unit configured to determine similarity between previously-stored location determination information of the terminal and current location determination information of the terminal in re-connection with the set-top box when making the re-connection with the set-top box after terminating the connection with the set-top box; and
a device searching unit configured to search for the set-top box for inter-device connection for a period shorter than a period before the determining of the similarity when the previously-stored location determination information of the terminal is similar to the current location determination information of the terminal in the re-connection.

11. The system of claim 8, wherein the local network connecting unit is configured to make the connection with the terminal through near field communication (NFC) when within NFC range of the terminal.

12. The system of claim 9, wherein the local network connecting unit is configured to make the connection with the terminal using at least one of a bar code, a personal identification number (PIN) code, and a voice outputting device after Wi-Fi connection to provide the client application.

13. The system of claim 9, wherein the local network connecting unit further comprises a sound source providing unit configured to reproduce a setting guide sound source or a connection sound source to enable downloading of the client application through voice search of the terminal after Bluetooth connection, and
wherein the local network connecting unit guides reception of the client application as the setting guide sound source or the connection sound source, which is reproduced by the sound source providing unit, is recognized in the voice search of the terminal.

14. The system of claim 8, further comprising a data managing unit configured to receive and store at least one of a photograph, a moving picture, and a file, which are stored in the terminal, or configured to output the at least one of the photograph, the moving picture, and the file through a display device.

15. An inter-device connection method using a local network, the inter-device connection method comprising:
providing uniform resource locator (URL) information or installation information of a client application, which is embedded in a set-top box, to a terminal for inter-device connection using the local network; and
making connection between the terminal and the set-top box as the terminal receives the client application based on the uniform resource locator (URL) information or the installation information.

16. The inter-device connection method of claim 15, further comprising:
storing location determination information of the terminal when making the connection with the set-top box;
determining similarity between previously-stored location determination information of the terminal and current location determination information of the terminal in re-connection with the set-top box when making the re-connection with the set-top box after terminating the connection with the set-top box; and
searching for the set-top box for the inter-device connection for a period shorter than a period before the determining of the similarity when the previously-stored location determination information of the terminal is similar to the current location determination information of the terminal in the re-connection.
